(19) United States
(12) Patent Application Publication
(10) Pub. No.: US 2025/0311732 A1
(43) Pub. Date: Oct. 9, 2025

(54) PEST CONTROL COMPOSITIONS

(71) Applicants: Dow Global Technologies LLC, Midland, MI (US); Rohm and Haas Company, Collegeville, PA (US)

(72) Inventors: Selvanathan Arumugam, West Chester, PA (US); Caroline Woelfle-Gupta, Midland, MI (US); Matthew Carter, Bala Cynwyd, PA (US)

(21) Appl. No.: 18/863,237

(22) PCT Filed: May 31, 2022
(86) PCT No.: PCT/US2022/031539

§ 371 Date: Nov. 5, 2024

(51) Int. Cl. A01N 63/23; A01N 25/10; A01N 25/28; A01P 7/04

(52) U.S. Cl. CPC A01N 63/23; A01N 25/10; A01N 25/28; A01P 7/04

(57) ABSTRACT

A pest control composition includes a plurality of composite particles, each of the composite particles includes a polyolefin core, wherein the polyolefin of the polyolefin core has 50 wt % or more of monomeric structural units derived from an olefin monomer based upon a total weight of the polyolefin. Each of the composite particles also includes a plurality of monomeric structural units derived from a vinyl monomer polymerized onto the polyolefin core, wherein the vinyl monomer includes one or more (meth)acrylic monomer. The composition also includes Bacillus thuringiensis and water.

### FIELD OF DISCLOSURE

The present disclosure is generally related to pest control compositions, and more specifically to pest control compositions comprising composite particles.

### BACKGROUND

Pest control agents are utilized to control pests, such as insects. The effectiveness of pest control agents can be influenced by a number of factors. There is continued focus in the industry on developing new and improved pest control compositions.

### SUMMARY

According to a first feature of the present disclosure, a pest control composition includes a plurality of composite particles, each of the composite particles includes a polyolefin core, wherein the polyolefin of the polyolefin core has 50 wt % or more of monomeric structural units derived from an olefin monomer based upon a total weight of the polyolefin. Each of the composite particles also includes a plurality of monomeric structural units derived from a vinyl monomer polymerized onto the polyolefin core, wherein the vinyl monomer includes one or more (meth)acrylic monomer. The composition also includes Bacillus thuringiensis and water. According to a second feature of the present disclosure, the composite particles are from 0.1 wt % to 15.0 wt % of the composition based upon a total weight of a combination of the composite particles, the pest control agent, and the water. According to a third feature of the present disclosure, the polyolefin core of the composite particles comprises an ethylene/octene copolymer. According to a fourth feature of the present disclosure, the water is from 20.00 wt % to 99.89 wt % of the composition based upon the total weight of the combination of the composite particles the pest control agent, and the water. According to a fifth feature of the present disclosure, the composite particles have a weight ratio of polyolefin core to the monomeric structural units derived from a vinyl monomer from 90:10 to 60:40. According to a sixth feature, the composite particles have a weight ratio of polyolefin core to monomeric structural units derived from a vinyl monomer of 80:20. According to a seventh feature, the polyolefin core is crosslinked.

### DETAILED DESCRIPTION

All ranges include endpoints unless otherwise stated. Subscript values in polymer formulae refer to mole average values for the designated component in the polymer.

Test methods refer to the most recent test method as of the priority date of this document unless a date is indicated with the test method number as a hyphenated two-digit number. References to test methods contain both a reference to the testing society and the test method number. Test method organizations are referenced by one of the following abbreviations: ASTM refers to ASTM International (formerly known as American Society for Testing and Materials); EN refers to European Norm; DIN refers to Deutsches Institut für Normung; and ISO refers to International Organization for Standards.

As used herein, a “wt %” or “weight percent” or “percent by weight” of a component, unless specifically stated to the contrary, is based on the total weight of the composition or article in which the component is included. As used herein, all percentages are by weight unless indicated otherwise.

Pest control compositions are disclosed herein. Embodiments of the present disclosure provide that the pest control compositions include a plurality of composite particles, a Bacillus thuringiensis, and water.

The pest control compositions disclosed herein may be applied to plants, e.g., plant surfaces, to control pests. Advantageously, the pest control compositions disclosed herein can provide improved, i.e., greater, residual protein concentrations for Bacillus thuringiensis following exposure to rain, as compared to other formulations. The improved residual protein concentrations indicate that the pest control compositions disclosed herein can provide improved pest control, as compared to other formulations.

Further, the pest control compositions disclosed herein can provide a percentage of Bacillus thuringiensis activity retained greater than 80% following exposure to rain. Providing the percentage of Bacillus thuringiensis activity retained greater than 80% can indicate a desirable degree of rainfastness.

The pest control compositions disclosed herein include a plurality of composite particles. Embodiments of the present disclosure provide that each of the composite particles includes a polyolefin core and a plurality of monomeric structural units derived from a vinyl monomer polymerized onto the polyolefin core. The term “shell” may be used herein to generally describe the polymerization of the plurality of monomeric structural units derived from a vinyl monomer onto the polyolefin core, but the term “shell” in no way limits the distribution, orientation, spacing or continuity of the monomeric structural units derived from a vinyl monomer across the core.

As mentioned, the composite particles include a polyolefin core, e.g., a core polymer. As used herein a “polymer” has two or more of the same or different monomeric structural units derived from a number of monomers, e.g., homopolymers, copolymers, terpolymers, etc. “Monomeric structural unit”, as used herein in reference to polymers, indicates a portion of a polymer structure that results from the reaction of a monomer or monomers to form the polymer. “Different” in reference to monomeric structural units indicates that the monomeric polymer structural units differ from each other by at least one atom or are different isomerically. As used herein “polyolefin” refers to polymers having 50 wt % or more of monomeric structural units derived from an olefin, based upon a total weight of the polymer. “Olefin” refers to a compound, e.g., a monomer that is a hydrocarbon having one or more carbon-carbon double bond and having no aromatic rings. As used herein, “a” refers to one or more unless indicated otherwise. The polyolefin core may be crosslinked.

The core polymer comprises polyolefins. Embodiments of the present disclosure provide that the core polymer may include a hydrocarbon polyolefin and/or a non-hydrocarbon polyolefin. A polyolefin that includes monomeric structural units derived exclusively from hydrocarbon monomers is considered to be a hydrocarbon polyolefin, even if a small number of hetero groups is attached to the polyolefin, e.g., as fragments from an initiator and/or a chain transfer agent. For hydrocarbon polyolefins, the mole ratio of hetero atoms to polymerized units of all monomers is 0.001:1 or lower. A polyolefin that is not a hydrocarbon polyolefin is considered to be a non-hydrocarbon polyolefin, e.g., a polyolefin including one or more hetero groups. As used herein, an atom other than carbon and hydrogen is considered a “hetero” atom; a chemical group that contains one or more hetero atom is considered a “hetero” group.

Examples of hydrocarbon polyolefins include, but are not limited to, hydrocarbon polyolefins having monomeric structural units derived from ethylene and one or more alpha-olefins. Examples of alpha-olefins include propylene, 1-butene, 3-methyl-1-butene, 4-methyl-1-pentene, 3-methyl-1-pentene, 1-heptene, 1-hexene, 1-octene, 1-decene, 1-dodecene, and combinations thereof. Further examples of hydrocarbon polyolefins include polymers of one or more dienes with ethylene, with one or more alpha-olefins, or with a combination thereof. Examples of dienes include butadiene; dicyclopentadiene; 1,5-hexadiene; ethylidene norbornene; and vinyl norbornene.

Hydrocarbon polyolefins can be prepared using known equipment, reaction components, and reaction conditions. Hydrocarbon polyolefins can be obtained commercially. Examples of suitable, commercially available hydrocarbon polyolefins include, but are not limited to, those under the tradename VERSIFY™, NORDEL™, or ENGAGE™ available from The Dow Chemical Company, and those under the tradename VISTAMAXX™, VISTALON™, or EXACT™ available from ExxonMobil Chemical Company.

As mentioned, the core polymer may include a non-hydrocarbon polyolefin. The non-hydrocarbon polyolefin can include a hetero group. Examples of hetero groups include, but are not limited to, carboxyl groups, ester groups, anhydride groups, alkoxysilane groups, and combinations thereof. The hetero group may have been attached to a comonomer prior to polymerization or may have been added to the non-hydrocarbon polyolefin by grafting after polymerization. One or more embodiments of the present disclosure may utilize a maleic anhydride grafted onto a hydrocarbon polyolefin. An unsaturated compound containing a hetero atom may be grafted to a hydrocarbon polyolefin by any effective method, for example by a free radical method, for example in the presence of a free radical initiator or in the presence of ionizing radiation. Examples of non-hydrocarbon polyolefins are copolymers of one or more alpha-olefins with one or more monomers, such as vinyl acetate, ethyl acrylate, vinyl alcohol, vinyl chloride, and (meth)acrylic monomers.

Non-hydrocarbon polyolefins can be prepared using known equipment, reaction components, and reaction conditions. Non-hydrocarbon polyolefins can be obtained commercially. Examples of suitable, commercially available non-hydrocarbon polyolefins include, but are not limited to, those under the tradename AMPLIFY™, PARALOID™, or RETAIN™ available from The Dow Chemical Company, those under the tradename FUSABOND™ available from E. I. DuPont de Nemours, those under the tradename POLYBOND™ available from Chemtura Corporation, and those under the tradename LICOCENE™ polymers available from Clariant International Ltd.

The polyolefin core can include a crosslinker. For instance, the crosslinker may be utilized to crosslink the polyolefins of the polyolefin core. The crosslinker may be a monomeric crosslinker, a polymeric crosslinker, or a combination thereof. Examples of crosslinkers include, but are not limited to, triallyl isocyanurate; 1,3,5,7-tetravinyl-1,3,5,7-tetramethylcyclotetrasiloxane; triallyl cyanurate; triallyl trimellitate; tri(methylallyl) isocyanurate; tris(diallylamine)-s-triazine; triallyl phosphite; N,N-diallylacrylamide, N,N,N′,N′,N″,N″-hexaallylphosphoramide; N,N,N′,N′-tetraallylterephthalamide; N,N,N′,N′-tetraallylinalonamide; trivinyl isocyanurate; methyl-2,4,6-trivinyltrisiloxane; N,N′-m-phenylenebismaleimide; diallyl phthalate; tri(5-norbornyl-2-methylene) cyanurate; and combinations thereof. Monomeric crosslinkers may have two or more carbon-carbon double bonds; or 3 or more carbon-carbon double bonds. Examples of polymeric crosslinkers include, but are not limited to, polyolefins having carbon-carbon double bonds. Polymeric crosslinkers may be homopolymers, copolymers, or a combination thereof, that contains monomeric structural units derived from one or more diene.

The polyolefin core can be prepared using known equipment, reaction components, and reaction conditions. One example of a suitable method to prepare the polyolefin core is as follows.

One or more hydrocarbon polyolefins and one or more non-hydrocarbon polyolefin can be fed via a feed throat into an extruder. The hydrocarbon polyolefin and the non-hydrocarbon polyolefin may be added separately to the extruder; may be mixed together and then added to the extruder as a mixture; or may be compounded together by melt mixing prior to addition to the extruder. The crosslinker, if it is a solid at 25° C., can also be fed via the feed throat along with hydrocarbon polyolefin and non-hydrocarbon polyolefin. The crosslinker, if a liquid at 25° C., can be injected via a pump into a melt zone of the extruder. The hydrocarbon polyolefin, the non-hydrocarbon polyolefin, and the crosslinker can be mixed together in a melt state in the extruder and then emulsified in the extruder by the addition of water and a surfactant via pumps. Water can be added to provide a desired solids content. For instance, the emulsions can have a water content of 60 wt % to 90 wt %, based upon a total weight of the emulsion. Such emulsions can have a solids content of 5 wt % to 50 wt %, based upon a total weight of the emulsion. The surfactant may be from 0.5 wt % to 10 wt % of the emulsion, based upon a total weight of solids of the emulsion. As used herein, the terms “emulsion” and “dispersion” are used interchangeably. Examples of commercially available surfactants include those available under the tradename EMPICOL™, among others.

The surfactant can be an anionic surfactant, e.g., which includes a hydrocarbon group of 8 or more carbon atoms and an anionic group. The hydrocarbon group may be linear, branched, aromatic, or a combination thereof. The anionic group is a chemical group that, in water at pH of 7, carries a negative charge. Examples of anionic groups include, but are not limited to, phosphate groups, phosphonate groups, carboxylate groups, sulfate groups, and sulfonate groups. The anionic surfactants can include a (CH₂CH₂O)ₙ group, where n is from 1 to 20. The (CH₂CH₂O)ₙ group may be bonded to a sulfate group for instance.

One method of making such an emulsion is described in US Publication No. 2016/0177077. Additional water can then be added to the extruder to provide a dispersion exiting the extruder that has solids content of less than 70 wt %, based upon a total weight of the dispersion. One or more embodiments provide that the polyolefins are first emulsified as previously described, and then the crosslinker is added to the emulsion, preferably when the emulsion is held at a temperature above the melting point of one or more of the polyolefins.

After the dispersion prepared from the hydrocarbon polyolefin, the non-hydrocarbon, and the crosslinker has been formed, an initiator, such as a peroxide initiator can be combined with the dispersion. The peroxide initiator can have a structure: R¹—O—O—R², where R¹ and R² are each independently H or an organic group. R¹ and R² can each independently H or an alkyl group, e.g., alkyl groups independently having from 2 to 12 carbon atoms. Examples of the peroxide initiator include, but are not limited to, hydrogen peroxide, alkyl hydroperoxides, t-butyl hydroperoxide, and combinations thereof. The peroxide initiator can be utilized at a concentration from 0.02 wt % to 2 wt %, based upon a total weight of solids of the emulsion. Examples of other suitable imitators include thermal initiators and photo initiators.

When combining the initiator with the dispersion, a reducing agent may be utilized, e.g., to form a redox initiator with the peroxide initiator. Examples of reducing agents include, but are not limited to, ascorbic acid, isoascorbic acid, sodium formaldehyde sulfoxylate, tetramethyl ethylene diamine, sodium metabisulfites, and combinations thereof. A mole ratio of peroxide to reducing agent can be 0.7:1 or higher; 0.8:1 or higher; or 0.9:1 or higher; the mole ratio of peroxide to reducing agent can be 1.3:1 or lower; 1.2:1 or lower; or 1.1:1 or lower. An oxidation/reduction catalyst may be utilized for an oxidation/reduction reaction between the peroxide initiator and the reducing agent. Examples of the oxidation/reduction catalyst include, but are not limited to, a salt of iron (II); FeSO₄ may be utilized. The oxidation/reduction catalyst can be utilized at a concentration from 1 part per million (ppm) to 50 ppm, based upon a total weight of solids of the emulsion.

The polyolefin core can include from 50 wt % to 95 wt % of hydrocarbon polyolefin based upon a total weight of the polyolefin core, e.g., based upon a total weight of hydrocarbon polyolefin, non-hydrocarbon polyolefin, and crosslinker such that the total weight of hydrocarbon polyolefin, non-hydrocarbon polyolefin, and crosslinker sums to 100 wt %. All individual values and subranges from 50 wt % to 95 wt % are included; for example, the polyolefin core can have from a lower limit of 50 wt %, 55 wt %, 60 wt %, 65 wt %, 70 wt %, or 75 wt % to an upper limit of 95 wt %, 92 wt %, 90 wt %, 85 wt %, 83 wt %, or 80 wt % of hydrocarbon polyolefin based upon a total weight of the polyolefin core.

The polyolefin core can include from 2 wt % to 50 wt % of non-hydrocarbon polyolefin based upon a total weight of the polyolefin core, e.g., based upon a total weight of hydrocarbon polyolefin, non-hydrocarbon polyolefin, and crosslinker such that the total weight of hydrocarbon polyolefin, non-hydrocarbon polyolefin, and crosslinker sums to 100 wt %. All individual values and subranges from 2 wt % to 50 wt % are included; for example, the polyolefin core can have from a lower limit of 2 wt %, 3 wt %, 5 wt %, 7.5 wt %, 10 wt %, or 12 wt % to an upper limit of 50 wt %, 45 wt %, 40 wt %, 35 wt %, 30 wt %, or 20 wt % of non-hydrocarbon polyolefin based upon a total weight of the polyolefin core.

The polyolefin core can include from 0.5 wt % to 20 wt % of crosslinker based upon a total weight of the polyolefin core, e.g., based upon a total weight of hydrocarbon polyolefin, non-hydrocarbon polyolefin, and crosslinker such that the total weight of hydrocarbon polyolefin, non-hydrocarbon polyolefin, and crosslinker sums to 100 wt %. All individual values and subranges from 0.5 wt % to 20 wt % are included; for example, the polyolefin core can have from a lower limit of 0.5 wt %, 1.0 wt %, 1.5 wt %, 2.0 wt %, 2.5 wt %, or 3.0 wt % to an upper limit of 20 wt %, 18 wt %, 15 wt %, 12 wt %, or 10 wt % of crosslinker based upon a total weight of the polyolefin core.

As mentioned, the composite particle includes the polyolefin core and a shell comprising monomeric structural units derived from a vinyl monomer. The composite particles can be prepared by emulsion polymerization to form the shell; utilizing one or more vinyl monomers in the presence the polyolefin core particles, for example.

For instance, one or more vinyl monomers can be combined with water and a surfactant to form an emulsion of droplets in an aqueous medium, where the droplets contain a vinyl monomer, e.g., (meth)acrylic monomer. Then, a mixture that contains the dispersion of polyolefin core particles, e.g., as previously discussed, the emulsion of vinyl monomer droplets, and a water-soluble initiator can be formed. This mixture can be subjected to known emulsion polymerization conditions that cause the initiator to produce radicals and the shell, e.g., a polymer, comprising monomeric structural units derived from the vinyl monomer.

Examples of vinyl monomers include (meth)acrylic monomers, vinyl aromatic monomers, and combinations thereof. Examples of (meth)acrylic monomers include, but are not limited to, (meth)acrylic acid, unsubstituted alkyl esters thereof, substituted-alkyl esters thereof, and combinations thereof. Examples of unsubstituted alkyl esters of acrylic acid include, but are not limited to, those in which the alkyl group has from 2 to 18 carbon atoms. Examples of unsubstituted alkyl esters of methacrylic acid include, but are not limited to, those in which the alkyl group has 1 to 4 carbon atoms. One or more embodiments provide that the vinyl monomer is methyl methacrylate, butyl acrylate, or combinations thereof.

Embodiments of the present disclosure provide that the composite particles have a weight ratio of polyolefin core particles to the plurality of monomeric structural units derived from a vinyl monomer from 90:10 to 60:40. All individual values and subranges from 90:10 to 60:40 are included; for example, the composite particles can have a weight ratio of polyolefin core particles to the plurality of monomeric structural units derived from a vinyl monomer from 90:10; 85:15; 80:20; 75:25; 70:30; 65:35; or 60:40.

Following the emulsion polymerization process utilized to form the composite particles and/or dilution, the composite particles may be dispersed in an aqueous medium. Various amounts of water may be utilized for different applications. For instance, a dispersion including the composite particles can be from 15 wt % to 85 wt % solids based upon a total weight of the dispersion, e.g., a total weight of solid components and liquid components. All individual values and subranges from 15 wt % to 85 wt % are included; for example, the dispersion including the composite particles can have from a lower limit of 15 wt %, 20 wt %, 25 wt %, 30 wt %, 35 wt %, or 40 wt % to an upper limit of 85 wt %, 80 wt %, 75 wt %, 70 wt %, 65 wt % or, 60 wt % of solids based upon the total weight of the dispersion.

The composite particles can have a volume average particle diameter from 100 nanometers (nm) to 2000 nm. All individual values and subranges from 100 nm to 2000 nm are included; for example, the composite particles can have a volume average particle diameter from a lower limit of 100 nm, 150 nm, 200 nm, or 250 nm to an upper limit of 2000 nm, 1000 nm, 750 nm, or 500 nm. Particle size analysis is done using a Beckman Coulter LS 13320 Laser Light Scattering Particle Sizer (Beckman Coulter Inc., Fullerton, California)

The pest control compositions disclosed herein include the plurality of composite particles, wherein the composite particles include a polyolefin core and a shell comprising monomeric structural units derived from a vinyl monomer, as discussed herein. The composite particle may be utilized in the pest control composition as a component of a dispersion. The composite particle may be utilized in the pest control composition as a powder; e.g., a dispersion containing the composite particle may be dried to provide a powder that contains the composite particles. Suitable methods for removing water, i.e. drying, from the dispersion including the composite particles include, for example, spray drying and coagulation.

The pest control compositions disclosed herein include Bacillus thuringiensis. As defined herein, “Bacillus thuringiensis” is the spores and/or the crystallized proteins of the species Bacillus thuringiensis and includes all Bacillus thuringiensis subspecies exhibiting insecticidal properties. Examples of such subspecies include kurstaki, israelensis and aizawa. The Bacillus thuringiensis may be added to the pesticide formulation as either a solid or as part of a liquid formulation. The presence and subspecies of Bacillus thuringiensis is determined by Random Amplified Polymorphic DNA analysis. A commercially available liquid formulation of Bacillus thuringiensis is THURICIDE™ pesticide manufactured by CERTIS USA, Columbia, Maryland. Bacillus thuringiensis can produce insecticidal crystal proteins, e.g., Cry proteins and Cyt proteins, by sporulation. Greater activity, following exposure to light, can provide desirably improved pest control. Greater residual protein concentrations, e.g., residual Cry proteins concentration and/or Cyt proteins concentration, following exposure to rain can provide desirably improved pest control.

The pest control compositions disclosed herein can include water. Different amounts of water may be utilized for different applications.

One or more embodiments of the present disclosure provide that the pest control compositions disclosed herein can include an additive. Examples of additives include viscosity modifiers, pH modifiers, herbicides, fungicides, and combinations thereof, among others. Different amount of the additive may be utilized for various applications.

As mentioned, the pest control compositions disclosed herein include the composite particles. The composite particles can be from 0.1 wt % to 15.0 wt % of the pest control composition based upon a total weight of a combination of the composite particles, the Bacillus thuringiensis, and the water. For example, the composite particles may be 0.1 wt % or greater, or 0.5 wt % or greater, or 1.0 wt % or greater, or 1.5 wt % or greater, or 2.0 wt % or greater, or 2.5 wt % or greater, or 3.0 wt % or greater, or 3.5 wt % or greater, or 4.0 wt % or greater, or 4.5 wt % or greater, or 5.0 wt % or greater, or 5.5 wt % or greater, or 6.0 wt % or greater, or 6.5 wt % or greater, or 7.0 wt % or greater, or 7.5 wt % or greater, or 8.0 wt % or greater, or 8.5 wt % or greater, or 9.0 wt % or greater, or 9.5 wt % or greater, or 10.0 wt % or greater, or 10.5 wt % or greater, or 11.0 wt % or greater, or 11.5 wt % or greater, or 12.0 wt % or greater, or 12.5 wt % or greater, or 13.0 wt % or greater, or 13.5 wt % or greater, or 14.0 wt % or greater, or 14.5 wt % or greater, while at the same time, 15.0 wt % or less, or 14.5 wt % or less, or 14.0 wt % or less, or 13.5 wt % or less, or 13.0 wt % or less, or 12.5 wt % or less, or 12.0 wt % or less, or 11.5 wt % or less, or 11.0 wt % or less, or 10.5 wt % or less, or 10.0 wt % or less, or 9.5 wt % or less, or 9.0 wt % or less, or 8.5 wt % or less, or 8.0 wt % or less, or 7.5 wt % or less, or 7.0 wt % or less, or 6.5 wt % or less, or 6.0 wt % or less, or 5.5 wt % or less, or 5.0 wt % or less, or 4.5 wt % or less, or 4.0 wt % or less, or 3.5 wt % or less, or 3.0 wt % or less, or 2.5 wt % or less, or 2.0 wt % or less, or 1.5 wt % or less, or 1.0 wt % or less, or 0.5 wt % or less of the combination of the composite particles, the Bacillus thuringiensis, and the water.

The pest control compositions disclosed herein include Bacillus thuringiensis. The Bacillus thuringiensis can be from 0.01 wt % to 25.00 wt % of the pest control composition based upon a total weight of a combination of the composite particles, the Bacillus thuringiensis, and the water. All individual values and subranges from 0.01 wt % to 25.00 wt % are included; for example, the pest control composition can include the Bacillus thuringiensis from a lower limit of 0.01 wt %, 0.05 wt %, or 1.0 wt % to an upper limit of 25.00 wt %, 15.00 wt %, or 10.00 wt % based upon the total weight of the combination of the composite particles, the Bacillus thuringiensis, and the water.

The pest control compositions disclosed herein include water. The water can be from 60.00 wt % to 99.89 wt % of the pest control composition based upon a total weight of a combination of the composite particles, the Bacillus thuringiensis, and the water. All individual values and subranges from 20.00 wt % to 99.89 wt % are included; for example, the pest control composition can include the water from a lower limit of 20.00 wt %, 30.00 wt %, or 40.00 wt % to an upper limit of 99.89 wt %, 98.00 wt %, or 95.00 wt % based upon the total weight of the combination of the composite particles, the Bacillus thuringiensis, and the water. The water may be incorporated into the pest control compositions via a dispersion containing the composite particles and/or the water may be incorporated into the pest control composition by addition that is independent of the dispersion.

The pest control compositions disclosed herein can be formed using known equipment and processes. The components of the pest control compositions may be combined, e.g., mixed, to form the pest control compositions. For instance, the components of the pest control compositions may be added to a vessel and be agitated therein. The components of the pest control compositions may be combined in any order.

The pest control compositions disclosed herein may be applied to plants, e.g., plant surfaces, to control pests. The pest control compositions may be applied to plants using known equipment and processes. For instance, the pest control compositions may be sprayed, sprinkled, and/or poured, among other applications, to plants. Different amounts of the pest control composition may be applied to plants for various applications.

### EXAMPLES

In the Examples, various terms and designations for materials are used including, for instance, the following:

ENGAGE™ 8137 (hydrocarbon polyolefin, ethylene-octene copolymer, obtained from The Dow Chemical Company); LICOCENE™ PR MA 4351 (non-hydrocarbon polyolefin, maleated polyethylene wax, 5 weight percent maleic anhydride, obtained from Clariant); RETAIN™ 3000 (non-hydrocarbon polyolefin, ethylene/octene copolymer grafted with maleic anhydride groups, obtained from The Dow Chemical Company); EMPICOL™ ESB 70 (surfactant, sodium lauryl ether sulfate, obtained from Huntsman); triallyl isocyanurate (crosslinker, obtained from Nippon Kasei Chemicals); methyl methacrylate (vinyl monomer); butyl acrylate (vinyl monomer); copolymer of polyethylene-polyvinyl acetate (20 wt % polyethylene, 80 wt % vinyl acetate, CAS No: 24937-78-8 obtained from Polysciences Inc).

Composite particles were formed as follows. An aqueous polyolefin dispersion that included polyolefin core particles (which is referred to as the first dispersion) was prepared using a twin screw extruder (25 mm screw diameter, 48 L/D rotating at 450 rpm). ENGAGE™ 8137, LICOCENE™ PE MA 4351, and RETAIN™ 3000 were supplied to the feed throat of the extruder via a Schenck Mechatron loss-in-weight feeder and a Schenck volumetric feeder, respectively. Triallyl isocyanurate was injected into the polymer melt zone using Isco dual syringe pumps (obtained from Teledyne Isco, Inc.). The polymers were melt blended, and then emulsified in the presence of a first aqueous stream and EMPICOL™ ESB 40. The emulsion phase was then conveyed forward to the dilution and cooling zone of the extruder where additional water was added to form the aqueous dispersion having a solid content of less than 70 wt %, i.e., the first dispersion. The first aqueous stream and the dilution water were supplied by Isco dual syringe pumps. The barrel temperature of the extruder was set to 140-150° C. After the dispersion exited the extruder, it was further cooled and filtered through a 200 um mesh size bag filter. The aqueous polyolefin dispersion was 50 wt % solids in water and included polyolefin core particles, the aqueous polyolefin dispersion comprised: ENGAGE™ 8137 (79 wt %); LICOCENE™ 4351 (5 wt %); RETAIN™ 3000 (10 wt %); EMPICOL™ ESB (4 wt %); triallyl isocyanurate (2 wt %).

The first dispersion, i.e. the polyolefin dispersion that included polyolefin core particles, was diluted with water to approximately 40 wt % solids at a pH of 4-5 in a 1 L three-neck flask fitted with a condenser and a mechanical stirrer. The stirring rod was inserted through a Teflon adaptor and a glass sleeve and fitted through the center neck of the flask. The stirrer rate was set to 200 rpm and nitrogen was slowly purged through the reactor; cooling water was turned on to flow through the condenser. Next, 5 ppm of iron (II) sulfate heptahydrate and 25 ppm of ethylenediamine tetraacetic acid (EDTA), based on the diluted dispersion total weight, were added and the mixture was heated to 65° C. using a heating mantle. Solutions of tert-butyl hydroperoxide (t-BHP, 0.3 wt % based on the diluted dispersion total weight) and sodium formaldehyde sulfoxylate (SFS, 0.3 wt % based on the diluted dispersion total weight) in deionized water were fed into the reactor over 60 minutes using syringe pumps. The reactor was then held at 65° C. for 30 minutes. Separately, a monomer emulsion was prepared which contained methyl methacrylate (98 wt %) and butyl acrylate (2 wt %) in deionized water in the presence of sodium dodecylbenzene sulfonate (DS-4, 0.04 wt % based on a total weight of the methyl methacrylate and butyl acrylate). Solutions of t-BHP (0.2 wt % based on the total weight of the methyl methacrylate and butyl acrylate) and SFS (0.17 wt % based on the total weight of the methyl methacrylate and butyl acrylate) in deionized water were prepared and loaded into syringe pumps for delivery. The monomer emulsion and the t-BHP/SFS solutions were co-fed simultaneously into the reactor at 65° C. The monomer emulsion was fed over 60 minutes, and the t-BHP/SFS solutions were fed over 90 minutes total. The reactor was then held at 65° C. for 30 minutes before cooling the reactor contents, i.e., a dispersion including the composite particles as discussed herein (which is referred to as the second dispersion), to approximately 25° C. for filtration through a 150 um mesh filter. For the composite particles, the weight ratio of the polyolefin core particle to the plurality of monomeric structural units derived from a vinyl monomer was 80:20. The dispersion was 42.0 wt % solids and the composite particles had a volume average particle diameter of 350 nanometers. Particle size analysis was done with the Beckman Coulter LS 13320 Laser Light Scattering Particle Sizer (Beckman Coulter Inc., Fullerton, California).

Example 1, a pest control composition, was formed as follows. A portion of the second dispersion, THURICIDE™, and water were combined to provide Example 1. Example 1 included 2.5 wt % of the composite particles and the resulting formulation was further diluted to 2.5 grams/liter.

Comparative Example A was formed as Example 1, with the change that the first dispersion was utilized rather than the second. In forming Comparative Example A, the polyolefin dispersion was 52.5 wt % solids and a volume average particle diameter of 337 nanometers.

For Comparative Example B, copolymer of polyethylene-polyvinyl acetate was utilized. The copolymer of polyethylene-polyvinyl acetate, THURICIDE™, and water were combined to include 2.5 wt % of the copolymer and the resulting formulation was further diluted to 2.5 grams/liter.

For Comparative Example C, neither the first dispersion nor the second dispersion were utilized; THURICIDE™ was diluted to 2.5 grams/liter.

Residual protein concentrations and Bacillus thuringiensis activities for Example 1 and Comparative Examples A-C were determined as follows.

Pieces of parafilm (2 inches by 4 inches) were respectively placed on a black Leneta card and a Kimwipe was gently rubbed over the parafilm before removing the parafilm paper. An auto-pipettor was used to randomly place 15 drops (15-30 μL) of Example 1 and Comparative Examples A-C in an array on the respective parafilms, one parafilm for each Example/Comparative Example was utilized; the samples were vortex mixed between each set of 5 drops to maintain composition consistency. Then, the parafilms were dried in an incubator at approximately 28° C. for approximately 1 hour.

The dried parafilms were then subjected to simulated rain as follows. Each dried parafilm was respectively placed in an Exo Terra Monsoon RS400 Rainfall System (fitted with 2 Exo Terra standard nozzles without any extensions); the parafilm was 13 inches from the spray nozzle. Water was sprayed onto the parafilm at a flow rate of 1.5 liters/hour, measured at the substrate interface, for 5 minutes; after which the parafilm was allowed to dry.

Following exposure to the simulated rain, the samples were extracted. For extraction, each of the respective parafilms was cut such that each dot, resultant from the drops, was centered on an approximately 0.25-inch square. For each respective parafilm, all of the cut, dotted squares were placed into a glass vial to which Sodium Dodecyl Sulfate solution (1 milliliter, 2 weight percent sodium dodecyl sulfate in water) was added. Each glass vial was then sonicated and left to soak for approximately 8 hours. Sonication was repeated three times for the extractions.

Residual protein concentrations were determined by the bicinchoninic acid assay (BCA) as follows. PIERCE™ BCA Protein Assay Reagent A and PIERCE™ BCA Protein Assay Reagent B (both obtained from Thermo Scientific™) were combined Reagent A (2 milliliters) and Reagent B (40 microliters) to form a reagent mixture.

One hundred (100) microliters of each extracted sample (extracted Example land Comparative Examples A-C) was placed into a respective cuvette; then the reagent mixture (2 milliliters) was added to each cuvette; and then the cuvettes were incubated at 30° C. for approximately 2 hours. Absorption values at 562 nm, determined with a Cary 100 UV-Visible Spectrophotometer, were used to determine the residual protein concentrations. The results are reported in Table 1.

TABLE 1

| | Residual protein concentration |
|---|---|
| | (Weight percent of remaining active |
| | protein after simulated rain) |
| Example 1 | 50 ± 2 |
| Comparative Example A | 17 ± 3 |
| Comparative Example B | 22 ± 2 |
| Comparative Example C | 0 |

The data of Table 1 illustrates that Example 1 has an improved, i.e., greater, residual protein concentration as compared to each of Comparative Examples A-C.

The solutions, as extracted above, for Example 1 and Comparative Examples A-C were diluted to a desired starting concentration, using a 0.1 wt % solution of TWEEN™ 20 then then serially diluted at suitable concentrations and plated. The resultant Bacillus thuringiensis activities are reported in Table 2.

TABLE 2

| | Bacillus | Bacillus | |
|---|---|---|---|
| | thuringiensis | thuringiensis | Bacillus |
| | activity before | activity after | thuringiensis |
| | simulated rain | simulated rain | activity retained |
| | (CFU/mL) | (CFU/mL) | (percent) |
| Example 1 | 8.42 ± 0.11 | 8.19 ± 0.11 | 97 |
| Comparative | 8.80 ± 0.13 | 8.71 ± 0.10 | 99 |
| Example A | | | |
| Comparative | 8.72 ± 0.10 | 8.67 ± 0.12 | 99 |
| Example B | | | |
| Comparative | 8.53 ± 0.13 | 5.78 ± 0.10 | 68 |
| Example C | | | |

The data of Table 2 illustrates that each of Example 1 and Comparative Examples A-B had a percentage of Bacillus thuringiensis activity retained greater than 80%.

1. A pest control composition comprising:
a plurality of composite particles, each of the composite particles comprising:
a polyolefin core, wherein the polyolefin of the polyolefin core has 50 wt % or more of monomeric structural units derived from an olefin monomer based upon a total weight of the polyolefin; and
a plurality of monomeric structural units derived from a vinyl monomer polymerized onto the polyolefin core, wherein the vinyl monomer comprises one or more (meth)acrylic monomer;
Bacillus thuringiensis; and water.

2. The pest control composition of claim 1, wherein the composite particles are from 0.1 wt % to 15.0 wt % of the composition based upon a total weight of a combination of the composite particles, the bacillus thuringiensis, and the water.

3. The pest control composition of any one of claim 1, wherein the polyolefin core of the composite particles comprises an ethylene/octene copolymer.

4. The pest control composition of any one of claim 1, wherein the water is from 20.00 wt % to 99.89 wt % of the composition based upon the total weight of the combination of the composite particles the Bacillus thuringiensis, and the water.

5. The pest control composition of any one of claim 1, wherein the composite particles have a weight ratio of polyolefin core to monomeric structural units derived from a vinyl monomer from 90:10 to 60:40.

6. The pest control composition of claim 5, wherein the composite particles have a weight ratio of polyolefin core to monomeric structural units derived from a vinyl monomer of 80:20.

7. The pest control composition of any one of claim 1, wherein the polyolefin core is crosslinked.
